(19) United States
(12) Patent Application Publication
(10) Pub. No.: US 2017/0178550 A1
(43) Pub. Date: Jun. 22, 2017

(54) BACKLIT DISPLAY SYSTEM

(71) Applicant: Eric Miller, Wellesley, MA (US)

(72) Inventor: Eric Miller, Wellesley, MA (US)

(21) Appl. No.: 15/294,761

(22) Filed: Oct. 16, 2016

Related U.S. Application Data
(60) Provisional application No. 62/242,906, filed on Oct. 16, 2015.

(51) Int. Cl. G09F 13/04; G09F 13/18

(52) U.S. Cl. CPC G09F 13/0404; G09F 13/18; G09F 2013/0445; G09F 2013/0468; G09F 2013/049; G09F 2013/1831; G09F 2013/1881

(57) ABSTRACT

A backlit display system includes a display framework and a display fabric. The display frame has an inner perimeter defining a central open space and having mounted thereabout a plurality of light-emitting elements configured for emitting light into the central open space. The display fabric has a rearward, light-reflective back-lighting panel and a forward, light-permeable image-display panel supported by the display frame such that at least a portion of the central open space is situated between the back-lighting and image-display panels. A portion of the light emitted into the central open space from the light-emitting elements is reflected by the back-lighting panel toward the image-display panel through which it passes to illuminate an image defined on the image-display panel.

Priority based on Provisional Application, Ser. No. 62/242,906 filed Oct. 16, 2015, and entitled “BACKLIT DISPLAY SYSTEM” is claimed. Moreover, the entirety of the previous provisional application, including the drawings, is incorporated herein by reference as if set forth fully in the present application.

### BACKGROUND

Backlit displays are widely used for signage, advertising and, increasingly, trade show displays. In general, a backlit display include a light-permeable substrate including an image applied thereto, a framework for supporting the image-bearing substrate, and a light source situated behind the substrate such that, when the light source is energized, light emitted therefrom impinges upon a rear side the image-bearing substrate and passes therethrough, thereby illuminating the image for viewing by persons situated forward for a front side of the image-bearing substrate.

One issue with existing backlit displays including light sources aimed directly at the rear side of the image-bearing substrate is that the lighting is uneven. More specifically, so-called “hot spots” representing illumination of relatively greater intensity are readily discernable from the viewing side of the substrate. An unwanted distraction, uneven image illumination detracts from the message-sending power of the displayed image and is therefore a source of frustration for those employing backlit displays for messaging.

Another difficulty associated with existing backlit displays relates to the mounting within the framework of the image-bearing substrate, which may be, for example a flexible polymeric sheet (e.g., plastic) or fabric upon which an image is printed, for example. A common mechanism for retaining the image-bearing substrate with the framework is an elongated strip of flexible, elastomeric material configured for jamming within a bead channel defined about the periphery of the framework. An example of such a strip is known in the industry as silicon edge bead. Using silicon edge bead, an image-bearing substrate is temporarily secured to the framework in much the same way the mesh of a window screen is secured to and within the window screen frame. It is not difficult to appreciate that a relatively high degree of skill is required to mount such an image-bearing substrate within its frame with introducing ripples and wrinkles. Moreover, even for those with experience and requisite skill, the process is time-consuming. This time-consuming and arduous tasks might be acceptable for semi-permanent or other long-duration displays, but present substantial unwanted delays in the setting of short-duration displays such as those employed at trade shows, for example.

Accordingly, a need exists for a backlit display system that that can be deployed simply and rapidly, and which evenly illuminates a displayed image.

### SUMMARY

Alternative embodiments of a backlit display system have in common a display fabric and a display framework configured for selectively supporting the display fabric. The display framework includes frame front and rear sides and an outer perimeter and inner perimeter, with the inner perimeter defining a central open space. The display fabric has mutually distinct back-lighting and image-display panels and is configured such that, when the display fabric is being supported by and about the display framework, (i) the back-lighting panel is adjacent and rearward of the frame rear side, (ii) the image-display panel is adjacent and forward of the frame front side, and (iii) at least a portion of the central open space is situated between the back-lighting and image-display panels.

Peripherally disposed about the central open space along the inner perimeter of the display framework is a plurality of light-emitting elements arranged such that the light-emitting elements selectively emit light into the central open space. Although the particular form or type of the light-emitting element is not regarded as central to the novelty of the invention, illustrative examples nevertheless include (i) incandescent bulbs, (ii) light-emitting diodes (i.e., LEDs), and (iii) fluorescent bulbs.

When the display fabric is supported by and about the display framework, the image-display panel has an inside surface facing the central open space and an outside surface facing forwardly of the display framework. The back-lighting panel has an interior surface that is at least partially reflective and faces the central open space and an exterior surface facing rearwardly of the display framework. The image-display panel is at least partially light-permeable such that a portion of the light that is emitted from the light-emitting elements and reflected by the interior surface of the back-lighting panel impinges upon the inside surface of the image-display panel and exits through the outside surface of the image-display panel, thereby illuminating an image defined by the image-display panel.

It is to be understood that within the scope and contemplation of the invention are configurations in which both of two mutually joined panels of the display fabric function as both image-display and back-lighting panels. In such an embodiment, for instance, reference to one panel as an image-display panel and the other, opposed panel, as a back-lighting panel is entirely arbitrary since each such panel defines an image and also serves to partially transmit (pass) light and partially reflect light emitted into the central open space for exiting (passage) through the opposite panel. Although, in association with such configurations, reference to one panel as an image-display panel and the other as a back-lighting panel is arbitrary, such reference may be necessary in order to distinguish the panels for discussion purposes. Accordingly, for example, that panel adjacent and rearward of the frame rear side might still be principally referred to as the back-lighting panel, while the panel that is adjacent and forward of the frame front side might still be principally referred to as the image-display panel.

In each of an illustrative set of embodiments, the display framework is modular. More specifically, the display framework is comprised of a plurality of selectively and mutually joinable frame segments. Each frame segment may include longitudinally opposed segment male and female ends such that longitudinally adjacent first and second frame segments are joined by fitting the segment male end of the first frame segment into the segment female end of the adjoining second frame segment. In at least one version, an assembled frame segment comprises at least two selectively decoupleable frame sub-segments. In still an additional version, the frame sub-segments of a frame segment are mutually linked by a tether which is at least one of flexible and elastic. Although the frame segments and, where applicable, frame sub-segments may be variably configured, in at least some versions, they are of tubular configuration. Moreover, it will be readily appreciated that the frame segments can be fabricated from various alternative materials, metal and plastic being illustrative examples.

Representative embodiments are more completely described and depicted in the following detailed description and the accompanying drawings.

### BRIEF DESCRIPTION OF THE DRAWINGS

FIG. 1 shows a backlit display system including a display framework, a partially cut away image-displaying fabric fitted over the frame, and a plurality of light-emitting elements situated about a periphery of the framework for selectively illuminating an image displayed on the fabric;

FIG. 2 depicts an assembled modular display framework for a backlit display system; and

FIG. 2A shows modular frame segments of a modular display framework; a first frame segment including frame sub-segments in an assembled state and a second frame segment including frame sub-segments in a disassembled state.

### DETAILED DESCRIPTION

The following description of variously embodied backlit display systems is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims. Moreover, among the various depicted embodiments, like reference numbers are used to refer to similar or analogous components.

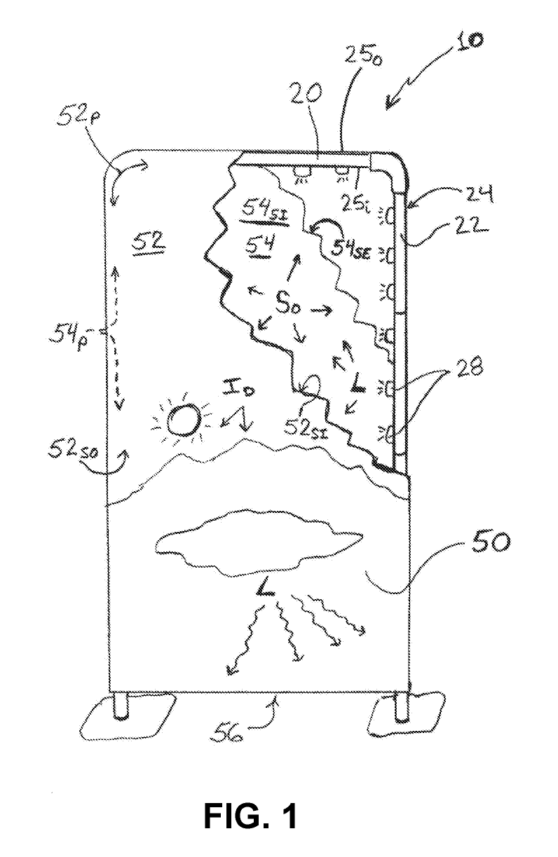

Referring initially to FIG. 1, a first embodiment of a backlit display system 10 includes a display framework 20 and a display fabric 50 configured for fitting over the framework 20. The display framework 20 has frame front and rear sides 22 and 24 and an outer and inner perimeter 25ₒ and 25ᵢ. The inner perimeter 25ᵢ defines a central open space S_{O}. A plurality of light-emitting elements 28 is disposed along the inner perimeter 25ᵢ of the display framework 20, and peripherally disposed about the central open space S_{O}, such that, when they are operatively energized, the light-emitting elements 28 emit light into the central open space S_{O}.

The display fabric 50—a cutaway view of which is depicted in FIG. 1—has mutually distinct image-display and back-lighting panels 52 and 54. The image-display panel 52 defines a displayed image I_{D} (alternatively, image I_{D}) which is, by way of non-limiting example, printed onto the portion of the display fabric 50 constituting the image-display panel 52 or woven of disparately-colored fibers defining the image I_{D}. When the backlit display system 10 is operatively assembled, the display fabric 50 is supported by and about the display framework 20 such that (i) the back-lighting panel 54 is adjacent to and rearward of the frame rear side 24 and the image-display panel 52 is adjacent to and forward of the frame front side 22. Moreover, the image-display and back-lighting panels 52 and 54 are mutually opposed with at least a portion of the central open space S_{O} situated between them.

With the backlit display system 10 thusly assembled, the image-display panel 52 has an inside surface 52_{SI} facing the central open space S_{O} and an outside surface 52_{SO} facing away from the central open space S_{O} and forwardly of the display framework 20. The back-lighting panel 54 has at least an interior surface 54_{SI} that is at least partially reflective (i.e., light-reflective) and an exterior surface 54_{SE}. The image-display panel 52 is at least partially light-permeable such that a portion of the light L that is emitted from the light-emitting elements 28 and reflected by the interior surface 54_{SI} of the back-lighting panel 54 impinges upon the inside surface 52_{SI} of the image-display panel 52 and exists through the outside surface 52_{SO} of the image-display panel 52. The displayed image I_{D} is thusly illuminated (i.e., backlit) by the passage of light L through the fabric image-display panel 52.

In various embodiments, the display fabric 50 is comprised of “tension fabric.” Tension fabric is somewhat stretchable and exhibits a memory property. Accordingly, a display fabric 50 that is properly sized and configured relative to the display framework 20 is such that—when supported by the display framework 20 in a display-operative mode—at least the image-display panel 52 is taut (e.g., stretched under tension). It will be appreciated that configuring the display fabric 50 and display framework 20 in observance of such parameters facilitates a displayed image I_{D} that is smooth and free of creases and wrinkles. Still additional embodiments are such that both the back-lighting and image-display panels 54 and 52 are taut when the display fabric 50 is supported by the display framework 20 in a display-operative mode.

In still more specific versions, the image-display and back-lighting panels 52 and 54 are mutually joined along their peripheries so as to define a “slip-cover” having an opening 56 through which the display framework 20 can be introduced. With reference to the illustrative version of FIG. 1, each of the image-display and back-lighting panels 52 and 54 is generally rectangular. The image-display panel 52 is bounded by a display-panel periphery 52_{P}, while the back-lighting panel 54 is bounded by a lighting-panel periphery 54_{P}. The peripheries 52_{P} and 54_{P} are joined to one another along three of four edges in order to define a display fabric 50 that resembles a pillow case. The particular means by which the panel peripheries 52_{P} and 54_{P} are joined is of no direct materiality to the points of novelty, but they could be permanently joined by stitching, for example, or temporarily joinable and separable by snaps or a zipper, by way of non-limiting example.

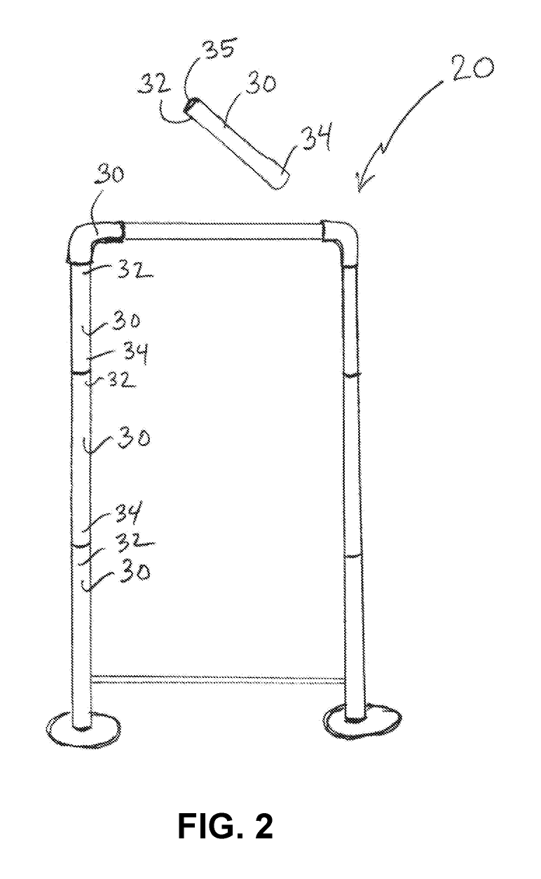

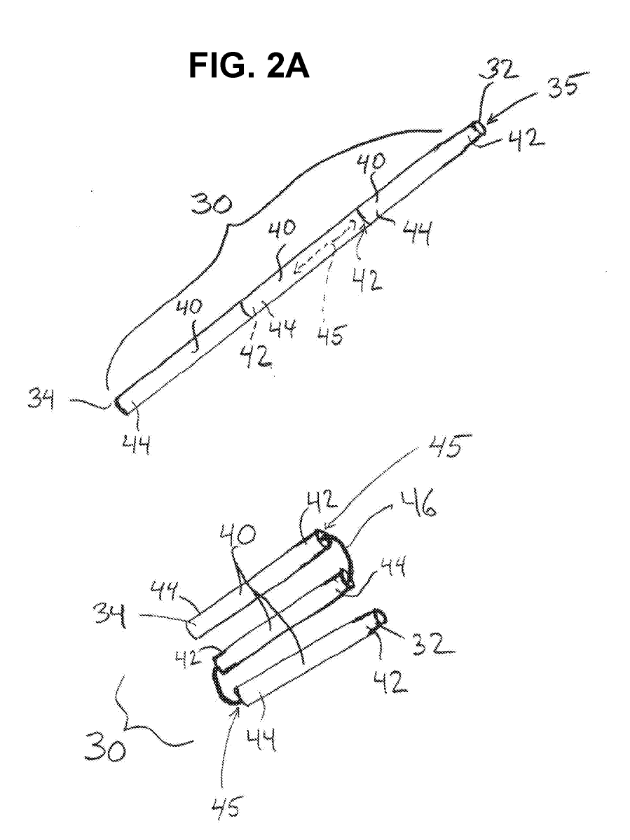

In various embodiments discussed with principal reference to the illustrative version of FIG. 2, the display framework 20 is modular. More specifically, in the version of FIG. 2, the display framework 20 is comprised of a plurality of frame segments 30, which in the particular illustrative, non-limiting embodiment shown, are tubular. Each tubular frame segment 30 includes a segment male end 32 and a segment female end 34 between which ends 32 and 34 there extends a hollow interior segment channel 35. Two adjacent frame segments 30 are joined by fitting the segment male end 32 of a first segment 30 into the segment female end 34 of the adjoining frame segment 30, in very much the same manner in which various types of tent and canopy poles are configured and assembled. Although tubular frame members are frequently cylindrical, tubular frame segments 30 of various alternative cross-sectional geometries are within the scope and contemplation of the invention.

Referring to FIG. 2A, some embodiments include tubular frame segments 30 that are themselves comprised of tubular frame sub-segments 40. Like the frame segments 30 of which they form a part, each frame sub-segment 40 includes a sub-segment male end 42 and a sub-segment female end 44 between which ends 42 and 44 there extends a hollow interior sub-segment channel 45. Two adjacent sub-segments 40 are joined by fitting the sub-segment male end 42 of a first sub-segment 40 into the sub-segment female end 44 of the adjoining frame sub-segment 40. The top portion of FIG. 2A shows an assembled frame segment 30, while the bottom portion of FIG. 2A depicts a disassembled frame segment 30.

It will be readily appreciated that, when at least two frame sub-segments 40 are cooperatively coupled to form an assembled frame segment 30 (top portion of FIG. 2A), the sub-segment male end 42 of the frame sub-segment 40 at one end of the frame segment 30 constitutes the segment male end 32, while the sub-segment female end 44 at the opposite end of the frame segment 30 constitutes the segment female end 34. In various configurations, the frame sub-segments 40 of a frame segment 30 are mutually linked by a flexible tether 46. More specifically, a first end 46A of the tether 46 is joined—within the sub-segment channel 45—to a frame sub-segment 40 at one end of the frame segment 30, while a second end 46B of the tether 46 is joined—within the sub-segment channel 45—to a frame sub-segment 40 at the opposite end of the frame segment 30. Furthermore, the tether 46 passes through the sub-segment channels 45 of all sub-segments 40 by which the frame segment 30 is defined. In addition to being flexible, the tether 46 is preferably elastic in order to accommodate the separation of sub-segments 40, while avoiding slack as the sub-segments 40 are mutually joined.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A backlit display system comprising:
a display framework having frame front and rear sides and an outer perimeter and inner perimeter, the inner perimeter defining a central open space;
a display fabric having mutually distinct back-lighting and image-display panels, the display fabric being supported by and about the display framework such that (i) the back-lighting panel is adjacent and rearward of the frame rear side, (ii) the image-display panel is adjacent and forward of the frame front side, and (iii) at least a portion of the central open space is situated between the back-lighting and image-display panels; and
a plurality of light-emitting elements peripherally disposed along the inner perimeter of the display framework such that they emit light into the central open space, wherein
(a) the image-display panel has an inside surface facing the central open space and an outside surface facing forwardly of the display framework;
(b) the back-lighting panel has an interior surface that is at least partially reflective; and
(c) the image-display panel is at least partially light-permeable such that a portion of the light that is emitted from the light-emitting elements and reflected by the interior surface of the back-lighting panel impinges upon the inside surface of the image-display panel and exists through the outside surface of the image-display panel, thereby illuminating an image defined by the image-display panel.

2. The backlit display system of claim 1 wherein the display fabric comprises tension fabric sized and configured relative to the display framework such that, when the display fabric is supported by the display framework in a display-operative mode, at least the image-display panel is taut.

3. The backlit display system of claim 2 wherein, when the display fabric is supported by the display framework in a display-operative mode, both the image-display panel and the back-lighting panel are taut.

4. The backlit display system of claim 3 wherein the image-display and back-lighting panels are mutually joined along peripheries of each panel so as to define a slip-cover having an opening through which the display framework can be introduced, thereby permitting a user to slip the display fabric over the display framework to render the backlit display system operatively assembled.

6. The backlit display system of claim 1 wherein the display framework comprises a plurality of tubular frame segments, each frame segment including longitudinally opposed segment male and female ends such that longitudinally adjacent first and second frame segments are joined by fitting the segment male end of the first frame segment into the segment female end of the adjoining second frame segment.

7. The backlit display system of claim 6 wherein at least one tubular segment comprises at least two selectively decoupleable tubular sub-segments.

8. The backlit display system of claim 7 wherein the at least two selectively decoupleable tubular sub-segments of at least one tubular segment are mutually linked by a tether that is at least one of flexible and elastic.

9. The backlit display system of claim 1 wherein, when the display fabric is supported by the display framework in a display-operative mode, both the image-display panel and the back-lighting panel are taut.

10. The backlit display system of claim 9 wherein the image-display and back-lighting panels are mutually joined along peripheries of each panel so as to define a slip-cover having an opening through which the display framework can be introduced, thereby permitting a user to slip the display fabric over the display framework to render the backlit display system operatively assembled.

11. The backlit display system of claim 10 wherein, both the image-display and back-lighting panels of the display fabric define displayed images and function as back-lighting panels.

12. A backlit display system comprising:
a display framework having frame front and rear sides and an inner perimeter defining a central open space;
a plurality of light-emitting elements disposed along the inner perimeter of the display framework such that the light-emitting elements emit light into the central open space; and
a display fabric having a rearward, light-reflective back-lighting panel and a forward, light-permeable image-display panel supported by the display frame such that (i) at least a portion of the central open space is situated between the back-lighting and image-display panels and (ii) a portion of the light emitted into the central open space from the light-emitting elements is reflected by the back-lighting panel toward the image-display panel through which it passes to illuminate an image defined on the image-display panel.

13. The backlit display system of claim 12 wherein the image-display and back-lighting panels are mutually joined along peripheries of each panel so as to define a slip-cover having an opening through which the display framework can be introduced, thereby permitting a user to slip the display fabric over the display framework to render the backlit display system operatively assembled.

14. The backlit display system of claim 13 wherein the display fabric comprises tension fabric sized and configured relative to the display framework such that, when the display fabric is supported by the display framework in a display-operative mode, the image-display and back-lighting panels are taut.
